(19) United States
(12) Patent Application Publication
(10) Pub. No.: US 2018/0031719 A1
(43) Pub. Date: Feb. 1, 2018

(54) Method and System for Generating a Subsurface Model

(71) Applicants: Hao Huang, Houston, TX (US); Dar-Lon Chang, Sugar Land, TX (US); Xiao-Hui Wu, Sugar Land, TX (US); Matthias Imhof, Katy, TX (US); Hayes F. Stripling, Spring, TX (US)

(72) Inventors: Hao Huang, Houston, TX (US); Dar-Lon Chang, Sugar Land, TX (US); Xiao-Hui Wu, Sugar Land, TX (US); Matthias Imhof, Katy, TX (US); Hayes F. Stripling, Spring, TX (US)

(21) Appl. No.: 15/659,461

(22) Filed: Jul. 25, 2017

Related U.S. Application Data
(60) Provisional application No. 62/368,595, filed on Jul. 29, 2016.

(51) Int. Cl. G01V 1/48; G06T 17/20

(52) U.S. Cl. CPC G01V 1/48; G06T 17/20; G01V 2210/66

(57) ABSTRACT

A method and system are described for creating a subsurface model. In this method, a framework is obtained that includes various objects associated with a subsurface region. A background mesh is generated to enclose the framework and then cell splitting is performed to modify the background mesh into a watertight model. The watertight model may be assigned properties and utilized in simulations to assist in performing hydrocarbon operations.

### CROSS-REFERENCE TO RELATED APPLICATION

This application claims the benefit of U.S. Provisional Patent Application 62/368,595 filed Jul. 29, 2016 entitled METHOD AND SYSTEM FOR GENERATING A SUBSURFACE MODEL, the entirety of which is incorporated by reference herein.

### FIELD OF THE INVENTION

This disclosure relates generally to the field of hydrocarbon exploration, development and production and, more particularly, to subsurface modeling. Specifically, the disclosure relates to a method for creating a framework for use in a subsurface model by leveraging representations conducive to change, thus providing rapid updating and encouraging the exploration of different scenarios and interpretations. The method may include constructing a watertight model for a subsurface region and using the subsurface model for reservoir simulations, which are used for hydrocarbon operations, such as hydrocarbon exploration, hydrocarbon development and/or hydrocarbon production.

### BACKGROUND

This section is intended to introduce various aspects of the art, which may be associated with exemplary embodiments of the present disclosure. This discussion is believed to assist in providing a framework to facilitate a better understanding of particular aspects of the present invention. Accordingly, it should be understood that this section should be read in this light, and not necessarily as admissions of prior art.

In exploration, development and/or production stages for resources, such as hydrocarbons, different types of subsurface models may be used to represent the subsurface structures, which may include a description of a subsurface structures and material properties for a subsurface region. For example, the subsurface model may be a watertight model, a geologic model or a reservoir model. The subsurface model may represent measured or interpreted data for the subsurface region, may be within a physical space or domain, and may include objects (e.g., horizons, faults, surfaces, volumes, and the like). The subsurface model may also be discretized with a mesh or a grid that includes nodes and forms cells (e.g., voxels or elements) within the model. By way of example, the watertight model may be created from a structural framework (e.g., organization of objects) and provide defined compartments or subvolumes. The geologic model may represent measured or interpreted data for the subsurface region, such as seismic data and well log data. The geologic model may be within a physical space or domain and may have material properties, such as rock properties. The reservoir model may be used to simulate flow of fluids within the subsurface region. Accordingly, the reservoir model may use the same mesh and/or cells as other models, or may resample or upscale the mesh and/or cells to lessen the computations for simulating the fluid flow.

The development of the reservoir model or geologic model may be problematic. For example, the process may include forming a mesh from objects, such as horizons and faults. The resulting mesh may not form closed compartments or subvolumes, which may be problematic for populating material properties into the objects and/or cells. In particular, the objects, which may overlap, may partially contact each other, thus, forming open areas or voids that are not closed compartments. As a result, the material properties may have to be assigned manually (e.g., by a designer, modeler or user) to only one object or cell at a time. In addition to being inefficient, the process may introduce errors and uncertainty through a manual process that is based on subjective decisions.

For example, a structural framework for a reservoir is formed from geological horizons and faults. This framework establishes the geometrical foundation for a three-dimensional mesh and provides some of the boundaries for volumes of similar rock and fluid properties. The resulting subsurface model may be used as the basis for volumetric computations, reservoir simulations, geomechanical analysis, and facilities and well planning.

One of the approaches to creating a framework is to specify the intersections amongst surfaces. However, surfaces may not align properly forming watertight frameworks. As a result, creating a framework is frequently a manually intensive process that is time consuming. Further, the creation process is further complicated for complex geologic interpretations. The process, which may involve numerous hours, may take several iterations and require significant simplification or elimination of major features using conventional approaches. Accordingly, the time consuming nature of the construction process for a single watertight framework makes it difficult to adjust or update the watertight framework based on subsequent interpreted data or to generate multiple variations to represent uncertainties in the seismic data interpretation.

Accordingly, there remains a need in the industry for methods and systems that are more efficient and may lessen problems associated with forming a subsurface model (e.g., a watertight model, a geologic model or a reservoir model) for use in hydrocarbon operations. Further, a need remains for efficient approaches to generate watertight frameworks that are automated, robust, efficient, and adaptable to change. The present techniques provide a method and apparatus that overcome one or more of the deficiencies discussed above.

### SUMMARY

In one embodiment, a method for generating a subsurface model having one or more object for a subsurface region is described. The method includes: obtaining a framework associated with a subsurface region, wherein the framework comprises a plurality of objects, wherein the plurality of objects comprise one or more of faults, horizons, and any combination thereof; generating a background mesh for the framework, wherein the background mesh comprises a plurality of cells; computing one or more level set functions for at least one of the plurality of objects (e.g., distance function); splitting one or more of the plurality of cells to conform to the plurality of objects within the framework to create a watertight model; and outputting the watertight model (e.g., storing or visualizing the watertight model).

In another embodiment, a system for generating a subsurface model having one or more objects associated with a subsurface region is described. The system comprises: a processor; an input device in communication with the processor and configured to receive input data associated with a subsurface region; and memory in communication with the processor, the memory having a set of instructions. The set of instructions, when executed, are configured to: obtain a framework associated with a subsurface region, wherein the framework comprises a plurality of objects, wherein the plurality of objects comprise one or more of faults, horizons, and any combination thereof; generate a background mesh for the framework, wherein the background mesh comprises a plurality of cells; compute one or more level set functions for at least one of the plurality of objects; split one or more of the plurality of cells to conform to the plurality of objects within the framework to create a watertight model; and output the watertight model.

### BRIEF DESCRIPTION OF THE DRAWINGS

The advantages of the present invention are better understood by referring to the following detailed description and the attached drawings.

FIGS. 1A, 1B and 1C are exemplary diagrams of frameworks.

FIG. 2 is an exemplary flow chart in accordance with an embodiment of the present techniques.

FIGS. 3A, 3B, 3C, 3D and 3E are diagrams associated with creating a watertight model in accordance with an embodiment of the present techniques.

FIG. 4 is a diagram of a background mesh and objects.

FIG. 5 is a diagram of an exemplary cell within a background mesh.

FIGS. 6A to 6F are additional exemplary diagrams associated with creating a watertight model in accordance with an embodiment of the present techniques.

FIGS. 7A to 7C are exemplary diagrams associated with creating a watertight model in accordance with an embodiment of the present techniques.

FIG. 8 is a block diagram of a computer system that may be used to perform any of the methods disclosed herein.

### DETAILED DESCRIPTION

In the following detailed description section, the specific embodiments of the present disclosure are described in connection with preferred embodiments. However, to the extent that the following description is specific to a particular embodiment or a particular use of the present disclosure, this is intended to be for exemplary purposes only and simply provides a description of the exemplary embodiments. Accordingly, the disclosure is not limited to the specific embodiments described below, but rather, it includes all alternatives, modifications, and equivalents falling within the true spirit and scope of the appended claims.

Various terms as used herein are defined below. To the extent a term used in a claim is not defined below, it should be given the broadest definition persons in the pertinent art have given that term as reflected in at least one printed publication or issued patent.

The articles “the”, “a” and “an” are not necessarily limited to mean only one, but rather are inclusive and open ended so as to include, optionally, multiple such elements.

As used herein, the term “hydrocarbons” are generally defined as molecules formed primarily of carbon and hydrogen atoms such as oil and natural gas. Hydrocarbons may also include other elements or compounds, such as, but not limited to, halogens, metallic elements, nitrogen, oxygen, sulfur, hydrogen sulfide (H₂S) and carbon dioxide (CO₂). Hydrocarbons may be produced from hydrocarbon reservoirs through wells penetrating a hydrocarbon containing formation. Hydrocarbons derived from a hydrocarbon reservoir may include, but are not limited to, petroleum, kerogen, bitumen, pyrobitumen, asphaltenes, tars, oils, natural gas, or combinations thereof. Hydrocarbons may be located within or adjacent to mineral matrices within the earth, termed reservoirs. Matrices may include, but are not limited to, sedimentary rock, sands, silicilytes, carbonates, diatomites, and other porous media.

As used herein, “hydrocarbon exploration” refers to any activity associated with determining the location of hydrocarbons in subsurface regions. Hydrocarbon exploration normally refers to any activity conducted to obtain measurements through acquisition of measured data associated with the subsurface formation and the associated modeling of the data to identify potential locations of hydrocarbon accumulations. Accordingly, hydrocarbon exploration includes acquiring measurement data, modeling of the measurement data to form subsurface models and determining the likely locations for hydrocarbon reservoirs within the subsurface. The measurement data may include seismic data, gravity data, magnetic data, electromagnetic data and the like.

As used herein, “hydrocarbon development” refers to any activity associated with planning of extraction and/or access to hydrocarbons in subsurface regions. Hydrocarbon development normally refers to any activity conducted to plan for access to and/or for production of hydrocarbons from the subsurface formation and the associated modeling of the data to identify preferred development approaches and methods. By way of example, hydrocarbon development may include modeling of the subsurface formation and extraction planning for periods of production; determining and planning equipment to be utilized and techniques to be utilized in extracting the hydrocarbons from the subsurface formation and the like.

As used herein, “hydrocarbon operations” refers to any activity associated with hydrocarbon exploration, hydrocarbon development and/or hydrocarbon production.

As used herein, “hydrocarbon production” refers to any activity associated with extracting hydrocarbons from subsurface location, such as a well or other opening. Hydrocarbon production normally refers to any activity conducted to form the wellbore along with any activity in or on the well after the well is completed. Accordingly, hydrocarbon production or extraction includes not only primary hydrocarbon extraction, but also secondary and tertiary production techniques, such as injection of gas or liquid for increasing drive pressure, mobilizing the hydrocarbon or treating by, for example chemicals or hydraulic fracturing the wellbore to promote increased flow, well servicing, well logging, and other well and wellbore treatments.

As used herein, “subsurface model” refers to a reservoir model, geomechanical model, watertight model and/or a geologic model. The subsurface model may include subsurface data distributed within the model in two-dimensions (e.g., distributed into a plurality of cells, such as elements or blocks), three-dimensions (e.g., distributed into a plurality of voxels) or three or more dimensions.

As used herein, “watertight” means that a containing specific volume can be divided into one or more volume compartments with boundaries that have no holes and no overlaps with other boundaries. A watertight framework of faults and horizons divides a containing specified volume of interest into one or more volume compartments that have boundaries completely enclosing the compartments. Each fault and horizon is either a boundary of or contained within a volume compartment without any piece outside of a compartment. For example, in a watertight triangular mesh framework, every triangle face on the boundary of a compartment shares each of its three edges with one other triangle to completely enclose the compartment. No two triangles may overlap partially. In some embodiment, no two triangles may overlap in their entirety. In another embodiment, this restriction is loosened only where two surfaces are merged. Within this compartment, there may be a partial fault that does not completely subdivide the compartment, and a triangle face on the edge of the partial fault may not share an edge with another triangle.

As used herein, “triangle” refers to a semi-planar polygon. Triangle may include quadrilateral or other polygons.

As used herein, “surface” refers to geologic features, such as horizon and fault, as well as technical features, such as model boundary, concession boundary, or artificial compartment boundary. A horizon separates two packages of rock. A fault is a discontinuity of rock packages. Often, a fault exhibits displacement. An artificial compartment boundary may be used for accounting purposes.

As used herein, “watertight model” is a model (e.g., three-dimensional model) of the subsurface region having a mesh representing various objects (e.g., faults and/or horizons) and forming one or more compartments.

As used herein, “geologic model” is a model (e.g., three-dimensional model) of the subsurface region having static properties and includes objects, such as faults and/or horizons, and properties, such as facies, lithology, porosity, permeability, or the proportion of sand and shale.

As used herein, “reservoir model” is a model (e.g., three-dimensional model) of the subsurface that in addition to static properties, such as porosity and permeability, also has dynamic properties that vary over the timescale of resource extraction, such as fluid composition, pressure, and relative permeability.

As used herein, “geomechanical model” is a model (e.g., three-dimensional model) of the subsurface that contain static properties, such as rock compressibility and Poisson's ratio, and model the mechanical response (e.g. compaction, subsidence, surface heaving, faulting, and seismic event) of the rock to fluid injection and extraction.

As used herein, “structural framework” or “framework” refer to a subsurface representation formed from objects (e.g., faults, horizons, other surfaces and model boundaries). For example, the framework is a subsurface representation that contains surfaces and polylines. A framework may be formed by surfaces of geologic, engineering, planning or other technical relevance.

As used herein, “concept” or “scenario” is a configuration of the framework with a given set of inputs parameters (e.g., order of objects). Some or all of the inputs may be moved, deformed, or intersected in a different order to form a different scenario.

As used herein, “zone”, “region”, “container”, or “compartment” is a defined space, area or volume contained in the framework or model, which may be bounded by one or more objects. The volume may include similar properties.

As used herein, “mesh” or “grid” is a representation of a region of space (e.g., 2-D domain or 3-D domain), which may include objects, and includes two or more nodes and a set of polygons or polyhedra disposed within the region (e.g., a volumetric representation). The mesh may represent each object by a set of polygons or polyhedra disposed within the region. Properties may be assigned to some or all polygons.

As used herein, “simulate” or “simulation” is the process of performing one or more operations using a subsurface model and any associated properties to create simulation results. For example, a simulation may involve computing a prediction related to the resource extraction based on a reservoir model. A reservoir simulation may involve performing by execution of a reservoir-simulator computer program on a processor, which computes composition, pressure, or movement of fluid as function of time and space for a specified scenario of injection and production wells by solving a set of reservoir fluid flow equations. A geomechanical simulation may involve performing by execution of a geomechanical simulator computer program on a processor, which computes displacement, strain, stress, shear slip, energy release of the rock as a function of time and space in response to fluid extraction and injection.

In hydrocarbon operations, a subsurface model is created in the physical space or domain to represent the subsurface region. The subsurface model is a computerized representation of a subsurface region based on geophysical and geological observations made on and below the surface of the Earth. The subsurface model may be a numerical equivalent of a three-dimensional geological map complemented by a description of physical quantities in the domain of interest. The subsurface model may include multiple dimensions and is delineated by objects, such as horizons and faults. The subsurface model may include a structural framework of objects, such as faults and horizons, and may include a mesh or grid of nodes to divide the structural framework and/or subsurface model into cells, which may include mesh elements or blocks in two-dimensions, mesh elements or voxels in three-dimensions or other suitable mesh elements in other dimensions. A cell, such as block, mesh element or voxel, is a subvolume of the space, which may be constructed from nodes within the mesh. In the subsurface model, material properties, such as rock properties (e.g., permeability and/or porosity), may be represented as continuous volumes or unfaulted volumes in the design space, while the physical space may be represented as discontinuous volumes or faulted volumes (e.g., contain volume discontinuities, such as post-depositional faults).

Within the subsurface models, a grid or mesh may be used to partition the model into different subvolumes, which may be used in hydrocarbon operations, such as reservoir simulation studies in reservoir exploration, development and/or production stages, as well as for representing a subsurface model description of a reservoir structure and material properties. Accordingly, the mesh may be configured to form cells that may represent material properties, such as rock and fluid properties, of a reservoir or may be used for numerical discretization of partial differential equations, such as fluid flow or wave propagation.

The present techniques provide enhancements in the generation of a surface mesh (e.g., forming a watertight framework from a structural framework) and optionally a volumetric mesh. In creating a subsurface model, a simplified representation for subsurface structures is utilized to create subsurface models that may be used in hydrocarbon operations. Thus, the present techniques may be used to enhance construction of subsurface models, which may be used for hydrocarbon operations and, more particularly, to enhance the use of subsurface modeling in hydrocarbon operations. For a subsurface model, a structural framework is created from subsurface measurements. The structural framework may include various objects, such as faults, horizons, and, if necessary, one or more surfaces that bound the area of interest. The different objects are meshed to define closed volumes (e.g., zones, compartments, or subvolumes). Then, the closed volumes are partitioned into small cells defined by the grid. Finally, properties are assigned to objects (e.g., surface transmissibility) and individual cells (e.g., rock type and/or porosity) in the structural framework to form the subsurface model. If the initial model is a geologic model, it may be upscaled to form a reservoir model.

As noted above, the representation and updating of subsurface models and/or frameworks involves complex computational challenges. Subsurface models may include objects (e.g., faults or horizons) that intersect each other in arbitrary ways. The present techniques involve various enhancements to forming a watertight framework. First, the present techniques automate the process of adjusting surface intersections and extensions to provide a watertight framework. This automation provides a robust handling of complex features (e.g., three-dimensional (3-D) features, such as y-faults, x-faults, and/or pinch-outs). In the present techniques, each object (e.g., surface, such as faults and horizons) has only local support or association with a background mesh (e.g., the object intersects a few cells of the background mesh, which are associated to each object). The local support refers to the level set function being defined for the specific cells that intersect the surface. The background mesh may be a mesh with regular spacing of cells, which overlays the subsurface volume that includes the objects. The background mesh may be non-conforming to the individual objects within the subsurface volume being represented. There may be local refinement of the background mesh to increase the number of cells in particular regions where objects tend to be located. As a result of associating each object with only the cells it intersects, the use of the background mesh (e.g., local refinement) provides computational efficiency and efficient updating with changes in input parameters (e.g., input data such as object). Further, the process may provide a watertight volumetric mesh as well as surface mesh. The watertight volumetric mesh may be used for unfaulting, geomechanical, geophysical, and/or reservoir simulation, while the surface mesh may be used as input for visualization or creating a new or updated volumetric mesh (e.g., has volumetric compartments filled with nodes forming polyhedra).

As another enhancement, level set functions along with mesh element or cell splitting may be used to find the intersection between objects. A level set function is an implicit function that defines one or more objects and integrates the values between the nodes in the cell. The level set function may be a nodal based function that represents an object (e.g., surface when the surface is set to zero). The value from the level set function may be equal to a distance value from the object, which may be positive or negative. Each level set function may be specific to a single object. For example, an object, such as a surface, that is represented by level set function may be easily extended, but finding the intersection of two level set functions may be problematic. Further, the level set function may be used to guide the extension of the surfaces and then volumetric cell splitting may be used to split the cells intersected by the surfaces. The intersection of two surfaces may then be identified as the edges of the sub-cell. The mesh element or cell splitting may be performed to divide the cell along the object passing through the cell.

The present techniques may be utilized to enhance the creation of a subsurface model. The subsurface model, which may include a reservoir model, geomechanical model, or geologic model, is a computerized representation of a subsurface region based on geophysical and geological observations associated with at least a portion of the specified subsurface region. Subsurface models, such as reservoir models, are typically used as input data for reservoir simulators or reservoir simulation programs that compute predictions for the behavior of rocks and fluids contained within a subsurface region under various scenarios of hydrocarbon recovery. Using subsurface models in simulations provides a mechanism to identify which recovery options offer the most economic, efficient, and effective development plans for a subsurface region (e.g., a particular reservoir and/or field).

Construction of a subsurface model is typically a multistep process. Initially, a structural model or structural framework is created from objects (e.g., surfaces, such as faults, horizons, and if necessary, additional surfaces that bound the area of interest for the model). The different objects define closed volumes, which may be referred to as zones, subvolumes, compartments and/or containers. Then, each zone is meshed or partitioned into sub-volumes (e.g., cells, mesh elements or voxels) defined by a mesh (e.g., a 3-D mesh or 3-D grid). Once the partitioning is performed, properties are assigned to objects (e.g., transmissibility) and individual sub-volumes (e.g., rock type, porosity, permeability, rock compressibility, or oil saturation). The objects (e.g., surfaces) are represented as meshes, while the cells form a mesh.

The assignment of cell properties is often also a multistep process where cells are assigned properties. For example, each cell may first be assigned a rock type, and then each rock type is assigned spatially-correlated reservoir properties and/or fluid properties. Each cell in the subsurface model may be assigned a rock type. The distribution of the rock types within the subsurface model may be controlled by several methods, including map boundary polygons, rock type probability maps, or statistically emplaced based on concepts. Further, the assignment of properties, such as rock type assignments, may be conditioned to well data.

Further, the reservoir properties may include reservoir quality parameters, such as porosity and permeability, but may include other properties, such as clay content, cementation factors, and other factors that affect the storage and deliverability of fluids contained in the pores of the rocks. Geostatistical techniques may be used to populate the cells with porosity and permeability values that are appropriate for the rock type of each cell. Rock pores are saturated with groundwater, oil or gas. Fluid saturations may be assigned to the different cells to indicate which fraction of their pore space is filled with the specified fluids. Fluid saturations and other fluid properties may be assigned deterministically or geostatistically.

Geostatistics interpolates observed data and superimposes an expected degree of variability. As an example, kriging, which uses the spatial correlation among data and intends to construct the interpolation via semi-variograms, may be used. To reproduce more realistic spatial variability and help assessing spatial uncertainty between data, geostatistical simulation is often used, for example based on variograms, training images, or parametric geological objects. Perturbing surface properties or cell properties, such as rock type, reservoir properties or fluid properties, is a conventional process, which may utilize deterministic or geostatistical methods to assign them. The assignment may include choosing a different variogram for kriging or a different seed for geostatistical simulation.

To enhance the subsurface model building process, the present techniques provide enhancements to the creation and generation of subsurface models. For example, in one embodiment, a method for generating a subsurface model having one or more object for a subsurface region is described. The method includes: obtaining a framework associated with a subsurface region, wherein the framework comprises objects, wherein the objects comprise faults, horizons, and any combination thereof; generating a background mesh for the framework, wherein the background mesh comprises various cells; computing a level set function for at least one of the plurality of objects (e.g., distance function); splitting one or more of cells to conform to objects within the framework to create a watertight model; and outputting the watertight model (e.g., storing or visualizing the watertight model).

In other embodiments, other enhancements may be utilized. For example, the level set function may be an implicit functions that defines one or more objects; the level set function may be a distance function, wherein the distance function is configured to compute a distance value from a specified object to a node in the background mesh; the distance function may be based on a Manhattan distance that is computed by propagating the distance from a first point to a second point; the distance function may be based on a Euclidian distance that is computed between a first point to a second point; and/or wherein the computing one or more level set functions for at least one of the plurality of objects and the splitting one or more of the plurality of cells to conform to the plurality of objects within the framework to create a watertight model is performed for each of the plurality of objects individually. Further, in other embodiments, the method may include assigning properties to one or more of the plurality of cells in the watertight model to form a subsurface model; wherein the subsurface model is a geologic model and the properties comprise one or more of facies, lithology, porosity, permeability, or the proportion of sand and shale, and any combination thereof; wherein the subsurface model is a reservoir model and the properties comprise one or more of porosity, permeability and any combination thereof; simulating fluid flow within the reservoir model to create simulation results; and/or managing hydrocarbon operations based on the simulation results. Further still, in other embodiments, the method may include defining an order for the plurality of objects; wherein the defined order for the plurality of objects represents a structural and/or stratigraphic interpretation of the inputted objects; wherein splitting one or more of the plurality of cells to conform to the plurality of objects within the framework to create a watertight model further comprises: identifying one or more first cells that intersect with a first object of the plurality of objects; and identifying one or more second cells that intersect with a second object of the plurality of objects, but excluding each cell that is one of the one or more first cells; wherein the first object has a higher priority in the defined order for the plurality of objects as compared to the second object; and truncating a portion of the second object that is associated with the one or more first cells; and/or wherein the splitting one or more of the plurality of cells to conform to the plurality of objects within the framework to create a watertight model; further comprising: performing a review of the plurality of cells that are split; identifying whether one or more of the cells are below an element quality metric threshold; and modifying the identified cells to revise the mesh (e.g., mesh used to create the watertight model). The method may also include wherein one or more level set functions are extended to meet another object or a boundary; wherein the level set function value at the new nodes of the background mesh during expansion are obtained by solving a partial differential equation; wherein an expected surface expansion direction or a normal direction of the expanded object is included in the partial differential equation; and/or wherein the normal direction of the expansion is chosen as the normal of the object at the front edge or the object that fits the object's front and the user specified points ahead of the front.

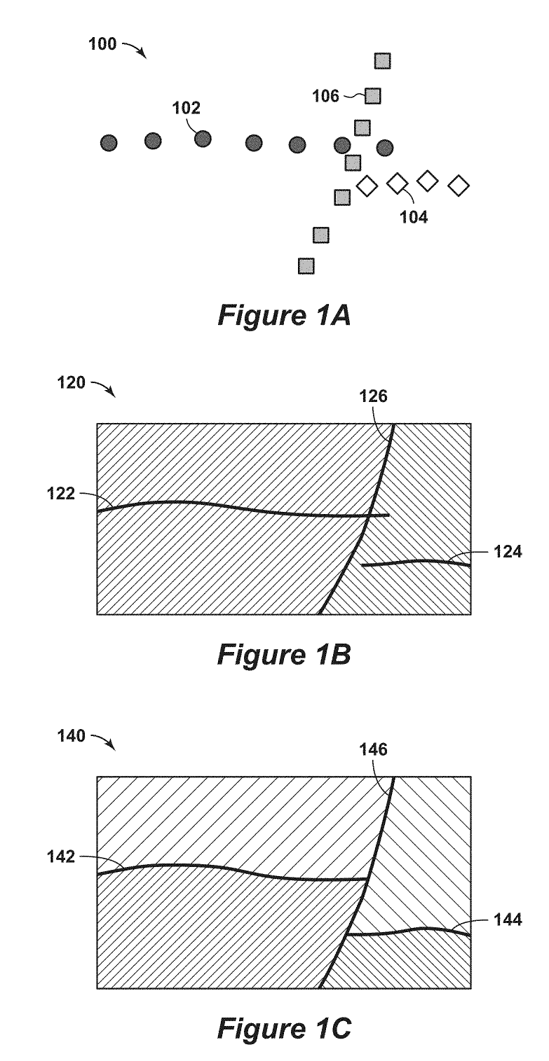

Beneficially, the present techniques provide various enhancements to the hydrocarbon extraction process. A framework may be generated with less effort, with less intervention and in a shorter time allowing the generation of a more realistic subsurface model, simulation and analysis of more complex models, and better quantification of risks and uncertainties. The present techniques may be further understood with reference to FIGS. 1A to 8, which are described further below.

FIGS. 1A, 1B and 1C are exemplary diagrams 100, 120 and 140 of frameworks. As noted above, specifying the intersections amongst objects (e.g., surfaces) is utilized to create a watertight framework. As shown in diagram 100 of FIG. 1A, the surfaces 102 and 104 are shown along with fault 106. The surface 102 extends beyond fault 106, while the surface 104 does not extend to fault 106. As a result, the surfaces 102 and 104 do not properly intersect fault 106. As shown in diagram 120 of FIG. 1B, the surfaces 122 and 124 are shown along with fault 126. The surface 122, which represents the surface 102, extends beyond fault 126, which represents the fault 106. By extending beyond the fault 126, the surface 122 may form one region to the left of the fault 126 or two regions divided by the surface 122 and to the left of the fault 126. The surface 124, which represents the surface 104, does not extend to the fault 126 and does not properly divide the region to the right of the fault 126. As a result, the surfaces 122 and 124 do not properly intersect fault 126 to form the different regions. FIG. 1C is a diagram 140 of adjusted intersections that form four regions. In diagram 140, the surfaces 142 and 144 are shown along with fault 146. The surface 142, which represents the surface 102, extends to the fault 146, which represents the fault 106. The portion of the surface 142 that extends beyond the fault 146 is removed or cut off to form a proper intersection between the surface 142 and 146. Accordingly, the surface 142 and fault 146 form two regions on the left side of the fault 146 in the diagram 140. Similarly, the surface 144, which represents the surface 104, intersects with the fault 146. The surface 144 and fault 146 form two regions on the right side of the fault 146 in the diagram 140. As a result, the proper intersections of the surfaces 142 and 144 and fault 146 form four distinct regions, which create a watertight framework.

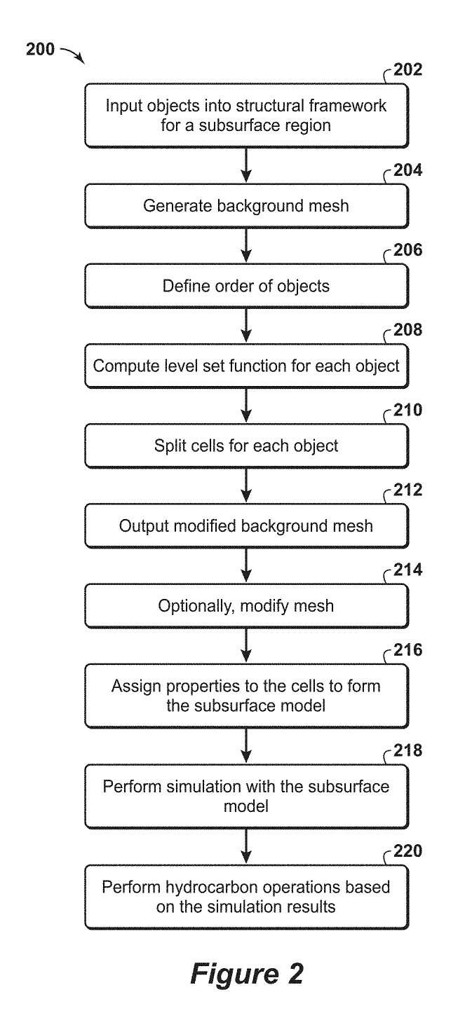

FIG. 2 is an exemplary flow chart 200 in accordance with an embodiment of the present techniques. The flow chart 200 includes a method for creating a subsurface model and using the created subsurface model for hydrocarbon operations. The method may include obtaining data and creating a watertight model from a structural framework for the subsurface region, as shown in blocks 202 to 214, assign properties to the watertight model to form one or more subsurface models, as shown in block 216, and using the subsurface model to perform simulations and for hydrocarbon operations, as shown in blocks 218 and 220.

To begin, the method involves obtaining data and creating a watertight model from a structural framework for the subsurface region, as shown in blocks 202 to 214. At block 202, objects are inputted into a structural framework for a subsurface region. The inputting of the objects may include inputting one or more surfaces, horizons, faults, and model boundaries into the structural framework.

Then, a background mesh may be generated for the structural framework, as shown in block 204. The generation of the background mesh may involve creating a mesh over or enclosing the structural framework (e.g., the objects within the structural framework). The background mesh may or may not conform to the objects in the structural framework. In block 206, an order of objects is defined. The order of objects may specify the order of interactions between the various object, which may include a prioritization of objects. For example, the order of objects may represent a structural and/or stratigraphic interpretation of the inputted surfaces (e.g., a specification or listing of how surfaces terminate or truncate with respect to each other). This may involve designating priority levels to objects. At block 208, the level set function for each object is computed. The computation of the level set function may include establishing on the background mesh for each object following the order of objects defined in block 206. While it may be preferred to compute a level set function for each object, it may also be used for two or more objects (e.g., the two or more object do not intersect). Then, at block 210, each of the cells for each object is split. The splitting of the cells may be performed in a manner to conform to or honoring the objects defined by the level set function and the order of objects. Then, the modified background mesh is outputted. The outputting of the modified background mesh may include storing the modified background mesh in memory and/or displaying the modified background mesh. In block 214, the modified background mesh may optionally be further modified. The further modification of the modified background mesh may involve moving certain meshes, joining or deleting small mesh elements (e.g., mesh elements below a specific threshold of an element quality metric), performing filtering or other processing on the mesh to address pinchouts and/or improperly formed mesh elements, for example. Further, the modifications may include user adjustments or performing algorithms to change the order of objects or deform and/or reposition one or more objects. The modified background mesh may be utilized as the watertight model (e.g., surface mesh and/or volumetric mesh) and/or may be utilized to create a simulation mesh (e.g., upscaled) for use in simulations. The surface mesh may be a mesh associated with a horizon or fault, while a volumetric mesh may be a mesh associated with a 3-D volume, which may be delineated by one or more objects. As may be appreciated, the watertight model may be visualized for interpretation and quality control.

Once the watertight model is created, properties are assigned to the cells to form the subsurface model, as shown in block 216. The assignment of properties may include assigning properties to cells associated with one or more objects or other individual sub-volumes. The properties may include transmissibility, rock type, porosity, permeability, rock compressibility, oil saturation, clay content and/or cementation factors, for example. The assignment of properties may include geostatistical techniques to populate the cells with property values that are appropriate for the cells. The properties assigned to the cells of the subsurface model may depend on the type of subsurface model, such as a reservoir model and/or a geologic model.

Once properties are assigned, the subsurface model may be utilized to perform simulations and the model and associated results may be used for hydrocarbon operations, as shown in blocks 218 and 220. At block 218, a simulation is performed with the subsurface model. The subsurface model may be a reservoir model or a geologic model and may be utilized to provide simulation results. The performing the simulation may include modeling fluid flow based on the reservoir model and the associated properties stored within the cells of the reservoir model. The simulation results may include the computation of time-varying fluid pressure and fluid compositions (e.g., oil, water, and gas saturation) and the prediction of fluid volumes produced or injected at wells. The performing the simulation may include modeling structural changes based on the geologic model and the associated properties stored within the cells of the geologic model. For example, reducing reservoir pressure may reduce porosity which may lead to a sagging overburden. The simulation results and/or the reservoir model may be outputted. The outputting of the simulation results and/or the subsurface model may include displaying the simulation results, the geologic model and/or the reservoir model on a monitor and/or storing the simulation results, the geologic model and/or the reservoir model in memory of a computer system. At block 220, the simulation results may be utilized to perform hydrocarbon operations. The hydrocarbon operations may include hydrocarbon exploration operations, hydrocarbon development operations and/or hydrocarbon production operations. For example, the simulation results, the geologic model and/or the reservoir model may be used to estimate or adjust reserves forecasts, reserves estimations and/or well performance prediction. As another example, the simulation results, the geologic model and/or the reservoir model may be used to adjust hydrocarbon production operations, such as installing or modifying a well or completion, modifying or adjusting drilling operations, decreasing fracture penetration, and/or to installing or modifying a production facility. The production facility may include one or more units to process and manage the flow of production fluids, such as hydrocarbons and/or water, from the formation.

Beneficially, this method provides an enhancement in the production, development and/or exploration of hydrocarbons. In particular, the method may be utilized to enhance development of a watertight model by providing an enhanced model with less computational effort, less interactive intervention, and/or in a computationally efficient manner. As a result, this may provide enhancements to production at lower costs and lower risk.

As may be appreciated, the blocks of FIG. 2 may be omitted, repeated, performed in a different order, or augmented with additional steps not shown. Some steps may be performed sequentially, while others may be executed simultaneously or concurrently in parallel. For example, in certain embodiments, the method may include performing blocks 208 and 210 for each object and then repeating these operations for another object. However, in another configuration, the compute level set function may be performed for each of the objects and then once it is complete, the cell splitting may be performed for each of the objects. Further, in other embodiments, defining an order of objects may be omitted, and the computing level set function and tessellation for objects may be performed in parallel. The later embodiment may be preferred if the object do not intersect each other within the framework. In other embodiments, the generation of background mesh and defining order of objects may be performed in parallel or with either being performed prior to the other.

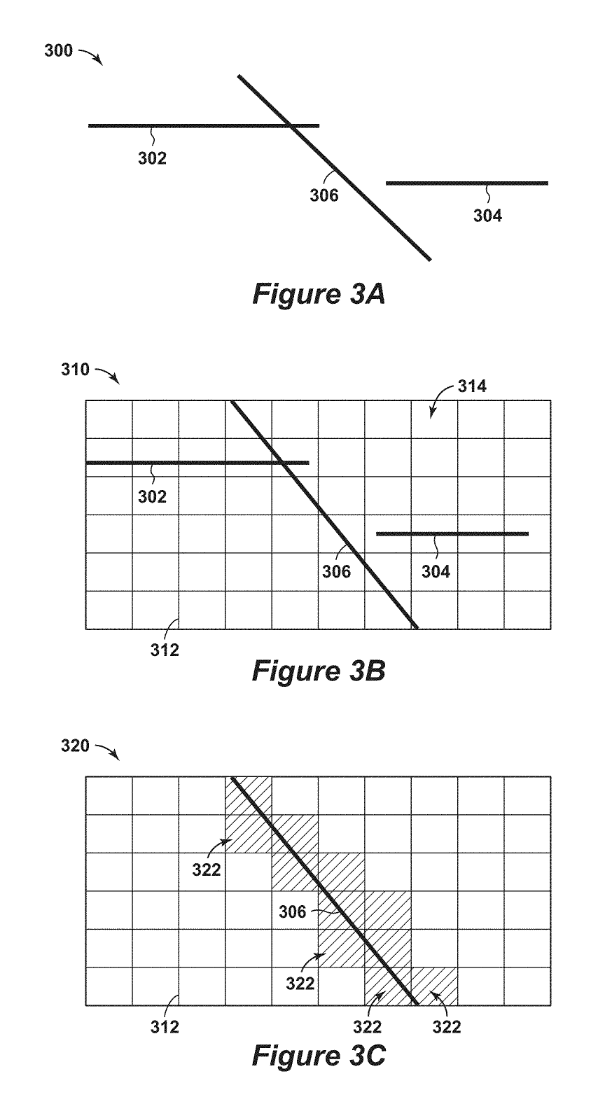

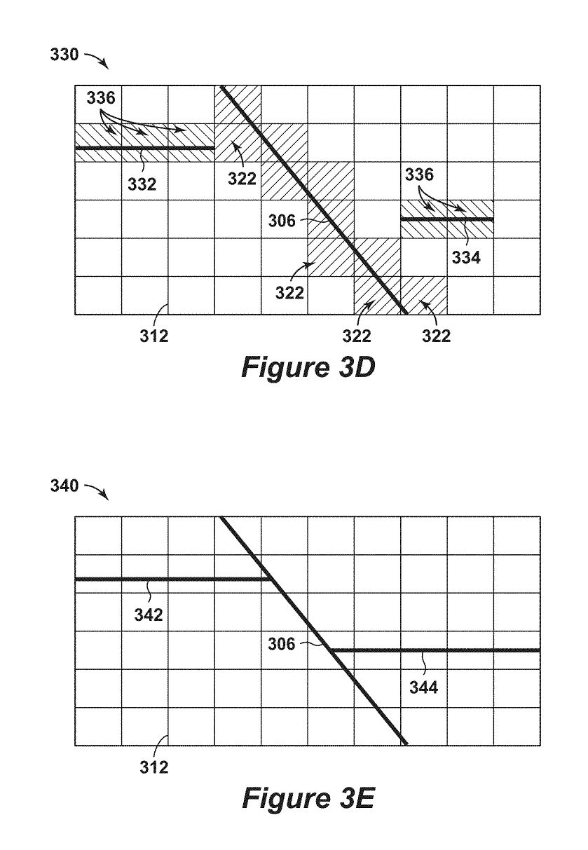

FIGS. 3A, 3B, 3C, 3D and 3E are diagrams 300, 310, 320, 330 and 340 associated with creating a watertight model in accordance with an embodiment of the present techniques. FIG. 3A is a diagram 300 of various objects, which include two horizons 302 and 304 and a fault 306 in a framework. The horizons 302 and 304 and fault 306 are inputted into the framework. In this diagram 300, the horizon 302 is interpreted too far and extends beyond the fault 306, while the interpretation of the horizon 304 does not reach the fault 306, but rather terminates prematurely. For these diagrams, the fault 306 is set at a higher order compared with the horizons 302 and 304 because the fault 306 is continuous and creates a displacement in the horizon forming horizons 302 and 304, splitting it into two pieces, which are horizons 302 and 304.

FIG. 3B is a diagram 310 of the generation of a background mesh. In this diagram 310, the objects from FIG. 3A are shown along with a background mesh 312. The background mesh 312 may include regularly spaced mesh elements or cells, such a cell 314, within the framework.

FIG. 3C is a diagram 320 of the generation of the level set function and cell splitting within the background mesh for the fault. In this diagram 320, the fault 306 from FIG. 3A is shown along with the background mesh 312. The cells that intersect the background mesh 312 and the fault 306, such as cells 322, are highlighted from the other cells in the background mesh 312.

FIG. 3D is a diagram 330 of the generation of the level set function and cell splitting within the background mesh for the horizons. In this diagram 330, the fault 306 and segments 332 and 334, which are portions of the horizons 302 and 304 from FIG. 3A, are shown along with the background mesh 312. The cells that intersect the background mesh 312 and the horizon segments 332 and 334, such as cells 336, are highlighted from the other cells in the background mesh 312, but not the previously highlighted cells, such as cells 322, from FIG. 3C.

FIG. 3E is a diagram 340 of the revised mesh. In this diagram 340, the horizon segments 332 and 334 of FIG. 3D are extended (or in other examples, truncated) to end at either the boundary or the fault 306 to form the horizons 342 and 344. Beneficially, the present techniques provide flexibility and may enhance adjustments to the framework. For example, if the fault 306 is repositioned, the cells that intersect the fault and any other objects may be subjected to the process, while other cells do not have to be adjusted.

As may be appreciated, in some embodiment, object points may be grouped, by other objects. For example, horizon points may be grouped by faults. In a preferred embodiment, groups of points that contain less than a specified number of points may be deleted. In another preferred embodiment, groups of points that lie on a specified side of a given object may be deleted. For example, groups of horizon points that are disposed on a specified side of a fault may be eliminated.

Returning to block 202 of FIG. 2, objects are inputted into a structural framework for a subsurface region. The objects may be represented by surfaces and/or polylines. For example, a set of objects, such as surfaces, may be obtained from performing a geologic or seismic interpretation using known techniques. The representations of the objects (e.g., surfaces) may be based on a set of specified points (e.g., nodes or vertices), where each point is defined by a triplet of x, y, and z coordinates. Some representations may use explicit coordinates for x and y, while others define x and y by use of a regular two-dimensional mesh. Some representations may be structured, which involve surface-forming polygons that are defined by an implicit or explicit multi-dimensional enumeration of the points. Other representations may be unstructured, which involve surface-forming polygons that are defined by further specification of the polygon edges, often by use of a sequential point enumeration. Some objects may be represented by implicit functions, such as radial basis functions, while other representations of an object may include a set of polylines representing fault sticks or horizons picked on selected cross sections. Lastly, some representations may not utilize polygons and rely upon a list of points, such as a point cloud.

Regardless of the object representations, a unique value from a signed distance function from a point to the object is the information that is utilized from the objects. The computation of the distance function may involve computational geometry or similar such techniques. By way of example, the computing of the signed distance may include computing a distance from a specified object to a point. The distance may be based on the Manhattan distance which can be computed by propagating the distance from one point to the next point. In a first iteration, a sign of the distance is determined. In such a determination, objects that lie directly above a point are labelled positive one (+1), while objects that lie directly below a point are labelled negative one (−1). Other configurations may reverse the designation of positive and negative. Regardless, the magnitude is increased when propagating the distances while the sign is passed along.

As another example, at a specified point, a distance of zero indicates that the point is located on or within the object. Given a distance function, the object may be reconstructed by use of a root finder that locates the roots or zeroes in this function. Although an unsigned distance may suffice to locate the object, it may be beneficial to define a signed distance function. First the signed distance function is easier to compute from a limited set of initial points. The object and thus the distance function may be interpolated between points and extrapolated away from the inputted points. Second, the distance function is used to locate the object. If the signs of the distance function between two points are different, then the object passes through the segment formed by the two points. If the signs of the distance function between two points are the same, then the object does not pass through the segment formed between the two points.

Further, boundaries for the model, framework or representation may be defined by surfaces or polylines. For example, the lateral model boundary, which may be referred to as the area of interest (AOI), may be specified by vertical extensions of a closed polyline in the horizontal plane. A list of polyline vertices on the boundary may be the input parameters, while other configurations may include analyzing the AOI to determine the boundary polyline vertices. The vertical extent of the framework may be specified by constant z coordinate values of horizontal planes or by explicitly provided objects, such as horizons or other surfaces. The combination of lateral and vertical boundaries may specify the volume of interest (VOI). In some configurations, an object may serve as both a mesh element of the framework and as a boundary of a VOI. Examples may include the use of a fault to laterally bound the VOI or the use of a horizon to vertically bound the VOI.

Returning to block 204 of FIG. 2, a background mesh is generated. The background mesh may be associated with a domain that encompasses the area of interest. As the background mesh does not have to honor any of the objects, the background mesh may be a structured Cartesian mesh, a non-conformal mesh, or an unstructured mesh. As an example, the background mesh may be a Cartesian mesh in two-dimensions or three-dimensions because the interpolation and extrapolation of the distance function is computationally efficient on this type of mesh. The background mesh may include different geometries for the cells formed by the mesh, such as quadrilaterals, hexahedrons, triangles, tetrahedrons, triangular prisms, hexagons and/or hexagonal prisms. In addition, the background mesh may be formed by combination of different mesh elements having different geometries and shapes, or by an unstructured mesh. For example, the creation of the background mesh may include dividing the volumetric region enclosing a framework into a regularly spaced mesh of nodes distributed within the region.

Returning to block 206 of FIG. 2, the order of objects is defined. The definition of the order of objects may be defined in a variety of methods. For example, if a surface S1 truncates another surface S2, then the surface S1 may be treated before surface S2. The truncation relationship between two object, such as surfaces, may be detected by calculating the signed distance function and determining the relationship based on the comparison of that calculation. For example, for a crossing fault (X-Fault), either of the surfaces, surface S1 or surface S2, may be given a higher ordering and used to split the other fault. If the surface S1 is given the higher ordering over surface S2, surface S2 may be split into two sub-faults. Boundaries may be treated first (e.g., as a higher in the order) because the boundaries truncate both faults and horizons. Faults may be given a higher order compared to horizons, which are usually discontinuous because of fault displacements. In one configuration, the order of objects may be specified by the user and inputted into the system, while other configurations may utilize an algorithm to compute the order of objects. In another configuration, the objects with the larger number of inputted points may dominate over an object with a lesser number of inputted points. Also, the object with the larger area spanned by the number of inputted points may dominate over an object with a smaller area spanned by the inputted points. Other configurations may rely on the number of inputted points on the different sides of an object to determine which side to maintain and which side to eliminate. Further still, other configurations may include using algorithms to define an order, an expert user is presented with this order, and the user may modify the order or submit a revised order of objects where necessary. Additionally, if surfaces are cutting into each other in a circuitous manner (e.g., surface A cuts into surface B, surface B cuts into surface C, and surface C cuts back into surface A), the three surfaces may be given the same order.

Returning to block 208 of FIG. 2, a level set function (e.g., distance functions) is computed for each object. The level set function may be computed for the highest order object in the order of objects, as noted above. The surface in question may be denoted as surface S. Preferably, the distance functions are computed at a plurality of nodes, faces, edges, and/or cell centers of the background mesh. In certain configurations, the distance functions are computed at and assigned to the nodes of the background mesh.

The method for computing the level set function may include various steps. By way of example, the first step may include identifying cells that are intersected by the objects, such as surface S, and then store the identified cells as a set A. The identified cells may be marked by a notification or flag. The previously marked cells, such as cells intersected by objects that have a higher order and are stored as a set B. Then, in a second step, values of level set functions are computed for nodes attached to cells in both sets A and B. The values may be determined by evaluating the signed distance function between the nodes and the object, such as surface S.

Then, in a third step, the level set function values grow into cells in set B that are not in set A (e.g., cells that are not intersected by the surface S). Various algorithms may be used to grow the values. One approach may be based on a global level set update scheme introduced in Jager for fracture propagation. See, e.g., Jager, P., Steinmann, P., Kuhl, E., (2008), Modeling three-dimensional crack propagation—A comparison of crack path tracking strategies, Int. J. Numer. Methods Eng. 76, p. 1328-1352.

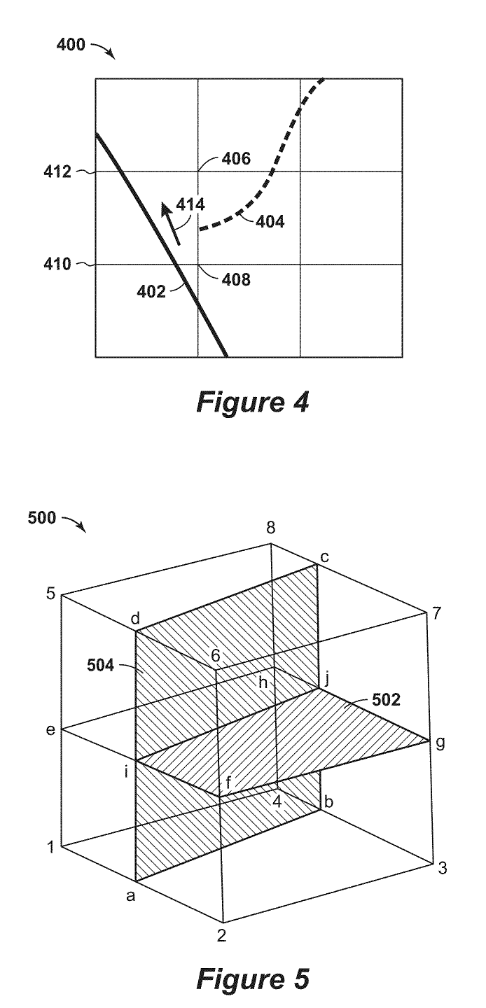

As an example of the third step, FIG. 4 is a diagram 400 of a background mesh and objects. In this diagram 400, the surface 404 should grow the level set function values into the cell surrounded by nodes 406, 408, 410 and 412. Before level set updating, the front of the surface 404 arrived at cell edge between nodes 406 and 408. Also, a normal perpendicular to the plane formed by the front may be formed along with the points that the user specified ahead of the front. The level set function values have been computed for nodes 406 and 408, but not nodes 410 and 412. The objective of this procedure is to define the level set function values for nodes 410 and 412. To achieve that, the following modified Laplace equation is solved using the finite element method in the cell, as shown in equations (e1) and (e2):

∇·(K∇φ)=0 (e1)

where

K=I−n [symbol] n (e2);

where n is the normal direction of the extension of surface 404 in the new cell, φ is the level set function to be sought, I is the identity tensor, K is the tensor that directs the growth of surface 404 through a cell so that the resulting surface extension within the cell has the normal direction 414. One can use the normal direction 414 of surface 404 at the cell edge between nodes 406 and 408. Also, the above differential equation can be solved with the boundary condition specified at nodes 406 and 408. The finite element procedure may yield level set function values at nodes 410 and 412 that define the extension of surface 404 with the normal direction 414. Instead of using the normal direction of surface 404 at the cell edge between nodes 406 and 408, the normal direction can be computed to improve the smoothness of intersection polylines generated by adjacent cell extensions of surface 404 into another surface 402. The smoothness of intersection polylines may be useful for subsequent tessellating of the cells. Alternative approaches to growing level set functions into adjacent cells are to specify level set values according to a threshold distance to pinch out two surfaces that are close to each other in a cell, or to set the level set values equal to those from a third surface intersecting with the opposite side of surface 402, such that the surface 404 and the third surface (not shown) are joined at their intersection with surface 402.

In a preferred embodiment, the modified Laplace equation is solved explicitly using a marching or region-growing algorithm. Starting with a background mesh cell that has a distance assigned to some but not all nodes, the distance function for the entire cell is computed by interpolation of the already defined values. Other configurations may include using distance function values from nearby nodes, where nearby is specified by an inputted distance. In yet another configuration, the modified Laplace equation may be solved implicitly by formation of a system of equations and initializing the system with the inputted points.

Various distance functions may be utilized within the present techniques for the distance measure. For example, the Euclidian distance may be utilized, but some configurations may weight the vertical distance component differently than the horizontal ones. In other configurations, non-Euclidian distances, such as the Manhattan distance, may be used.

In another configuration, one level set function may be used to define a surface, while another level set function may be used to define the bounding or trim surface. The intersection of the trim surface and the surface forms the boundary of that surface.

In the fourth step, cells in the set A and B may be tessellated or formed using the computed level set function values. Tessellation may be performed to produce a watertight framework of surface meshes that bound volume compartments, or tessellation may be performed for a 3-D volumetric mesh that is based on the level set surfaces and computed intersection curves. Various algorithms may be used to tessellate a surface mesh framework or a volumetric mesh suitable for numerical simulation. One example of such a tessellation algorithm is described in Huang for splitting cells at intersecting surfaces. See, e.g., Huang, H., Long, Ted A., Wan, J., Brown, W. P., (2011), On the use of enriched finite element method to model subsurface features in porous media flow problems, Computational Geosciences 15, p. 1573-1499. The intersection of two surfaces may then be identified as the edges of the sub-cell.

By way of example, FIG. 5 is a diagram of an exemplary cell within a background mesh. In this diagram 500, the volumetric cell is intersected first by a vertical surface 504 and then a horizontal surface 502. The nodal level set function values for the surface 504 are f1=−1, f2=1, f3=1.3, f4=−0.7, f5=−1, f6=1, f7=1.3, and f8=−0.7. The nodal level set function values for the surface 502 are f1=f2=f3=f4=−1, and f5=f6=f7=f8=1. It is assumed that the surface 502 extends towards the face formed by nodes 1, 4, 5, and 8, the surface 504 splits the cell into two sub-cell with the nodes at 1-4-8-5-a-b-c-d and 2-3-7-6-a-b-c-d, respectively. The surface 502 may then further split the latter into sub-cells with nodes 2-3-f-g-a-i-j-b and 6-7-g-f-c-j-i-d. After the cell splitting, the intersection of the two surfaces 502 and 504 may then be simply the line i-j.

If a surface is within a certain threshold or tolerance (e.g., too close to a vertex), it may cause difficulties for the cell splitting algorithm, resulting in low quality surface triangles. For such situations, the level set function value may become too small. Accordingly, a threshold value may be used for the level set function values to prevent performing a level set function for such objects. As may be appreciated, the level set function maps the distance to the global object, not the provided inputted object.

Returning to block 212 in FIG. 2, the modified background mesh may be outputted. The outputting of the modified background mesh may include visualization and quality control of the resulting watertight framework. A first configuration may include direct rendering of meshes and/or grids. The visualization may provide for interactive editing and modification of the framework that may be performed to further enhance or modify the mesh. The mesh may be modified because the mesh does not meet expectations. For example, an object may not pass through a known well marker point, two faults may exhibit the wrong major-minor relationship, a fault contact may flip polarity laterally; and/or the fault may appear to be a reverse fault in certain parts and a normal fault in other parts. In certain configurations, performing quality control may include computing aspect ratios for cells or meshes, computing maximal or dihedral angles, and/or computing size or volumes. In some embodiment, low quality elements may be split or merged. The modifications of the meshes may represent surface deformations and repositioning as a result of inspection. The cells which support the level set functions for the objects affected by editing need to have their level set values modified or vacated. After that, the associated mesh creation steps are reapplied to the objects at the updated point or location.

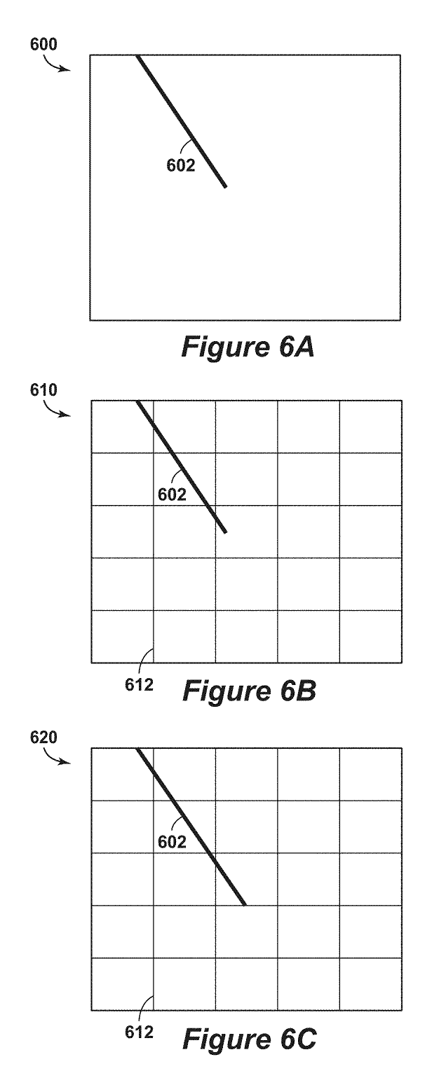

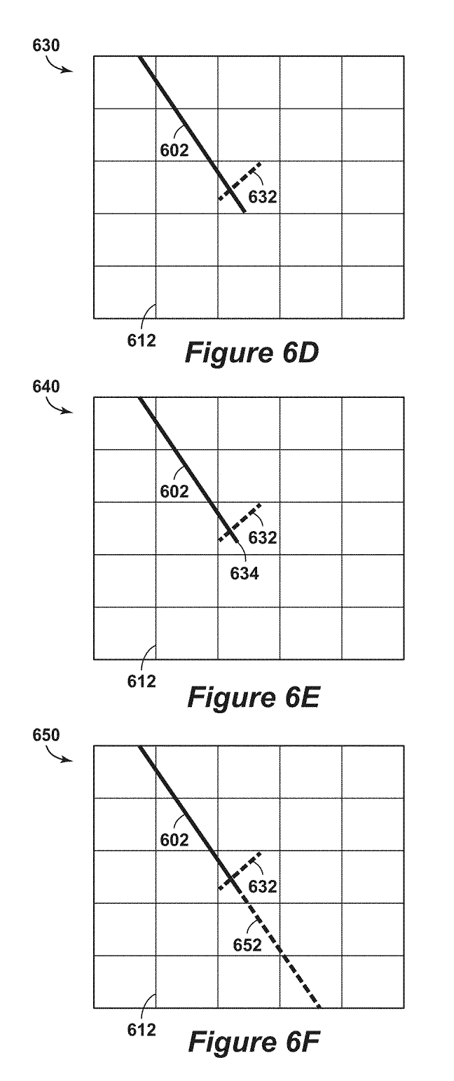

Some objects may not terminate on another object or model boundary. For example, a fault may not extend to another object and as a result not intersect another fault, object or boundary. In some situations, a fault may terminate within a domain of interest, such as the fault S. FIGS. 6A to 6F are additional exemplary diagrams 600, 610, 620, 630, 640 and 650 associated with creating a watertight model in accordance with an embodiment of the present techniques. In FIG. 6A, the diagram 600 includes a fault 602, which is also known as a partial fault. In FIG. 6B, the diagram 610 includes the fault 602 with the edge of the fault 602 may be located in the interior of a group of cells of the background mesh 612. The algorithm to address partial faults, such as fault 602, is exemplified in FIGS. 6C, 6D, 6E and 6F. First, the fault 602 is extended to the boundaries of the cells which contain the fault tip, as shown in FIG. 6C. Then, an edge cut 632, which is perpendicular to the fault 602 at the edge, is created, as shown in FIG. 6D. The edge cut may truncate the segment 634 from the fault 602, as shown in FIG. 6E. Optionally, segment 634 may be extended to either another fault or the boundaries of the domain of interest as shown by segment 652 in FIG. 6F.

In another embodiment, faults are not extrapolated beyond the limit of its inputted points. The distance function or level set remains undefined beyond this limit, by setting the function values to a specified value, such as undefined number or infinity. In another embodiment, the distance functions or level sets of partial faults are extrapolated for a specified distance beyond the inputted support. In a preferred embodiment, the distance functions or level sets for partial faults are simply extrapolated until they intersect a model boundary or another fault. In some embodiments, partial faults are ranked lower on the fault orders to ensure their truncation against other faults.

In some configurations, the level set functions may not be computed for every object independently. Rather, for a specified set of objects, one compound level set function may be computed. Instead of the zero value indicating the location of the object, each object of the set of objects is characterized by one mutually exclusive value. Preferably, the values may be ordered in a top-down or bottom-up manner. A disadvantage of this compound level set is that some surfaces may not truncate each other without explicit definition of a distance threshold based on vertical or Euclidian distance rather than level-set values.

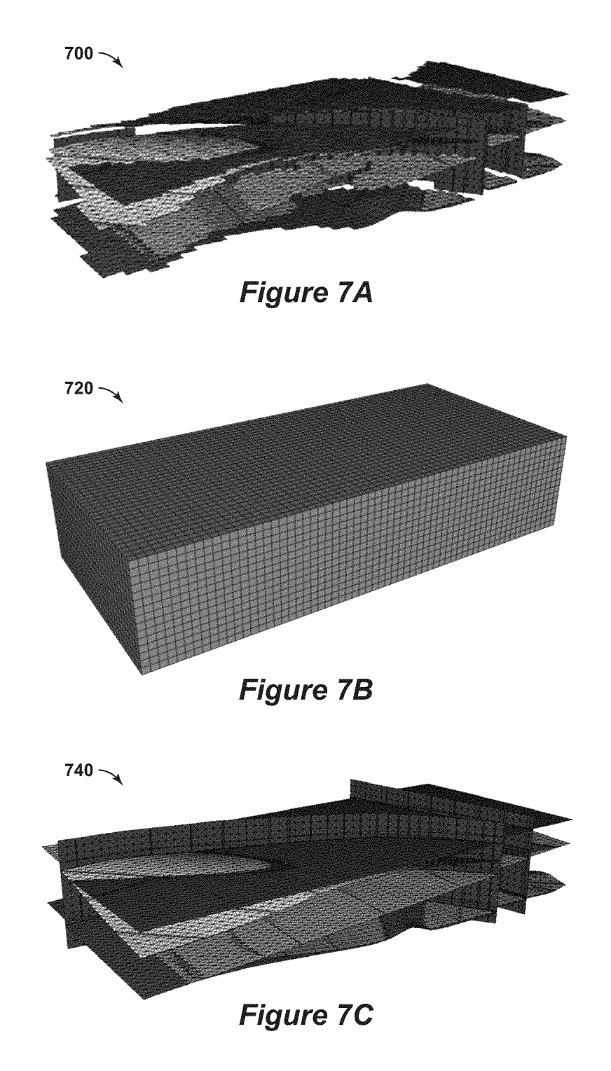

FIGS. 7A to 7C are exemplary diagrams 700, 720 and 740 associated with creating a watertight model in accordance with an embodiment of the present techniques. In these diagrams 700, 720 and 740, the example includes two faults and five horizons with pinch-outs (e.g., horizon intersecting horizon). In FIG. 7A, the diagram 700 shows the input objects in which the intersections between objects are not well defined. In FIG. 7B, the diagram 720 shows the background mesh that is employed in the method to generate the watertight framework. In FIG. 7C, the diagram 740 is the resulting watertight framework from performing the blocks in FIG. 2.

Persons skilled in the technical field will readily recognize that in practical applications of the disclosed methodology, it is partially performed on a computer, typically a suitably programmed digital computer. Further, some portions of the detailed descriptions which follow are presented in terms of procedures, steps, logic blocks, processing and other symbolic representations of operations on data bits within a computer memory. These descriptions and representations are the means used by those skilled in the data processing arts to most effectively convey the substance of their work to others skilled in the art. In the present application, a procedure, step, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “processing” or “computing”, “calculating”, “comparing”, “determining”, “displaying”, “copying,” “producing,” “storing,” “adding,” “applying,” “executing,” “maintaining,” “updating,” “creating,” “constructing” “generating” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present techniques also relate to an apparatus for performing the operations herein. This apparatus may be specially constructed for the required purposes, or it may comprise a general-purpose computer selectively activated or reconfigured by a computer program stored in the computer (e.g., one or more sets of instructions). Such a computer program may be stored in a computer readable medium. A computer-readable medium includes any mechanism for storing or transmitting information in a form readable by a machine (e.g., a computer). For example, but not limited to, a computer-readable (e.g., machine-readable) medium includes a machine (e.g., a computer) readable storage medium (e.g., read only memory (“ROM”), random access memory (“RAM”), magnetic disk storage media, optical storage media, flash memory devices, etc.), and a machine (e.g., computer) readable transmission medium (electrical, optical, acoustical or other form of propagated signals (e.g., carrier waves, infrared signals, digital signals, etc.)).

Furthermore, as will be apparent to one of ordinary skill in the relevant art, the modules, features, attributes, methodologies, and other aspects of the invention can be implemented as software, hardware, firmware or any combination of the three. Of course, wherever a component of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of skill in the art of computer programming. Additionally, the present invention is in no way limited to implementation in any specific operating system or environment.

Further, one or more embodiments may include methods that are performed by executing one or more sets of instructions to perform modeling enhancements in various stages. For example, the method may include executing one or more sets of instructions to perform comparisons between thresholds current statuses or indications along with transmitting data between modules, components and/or sensors.

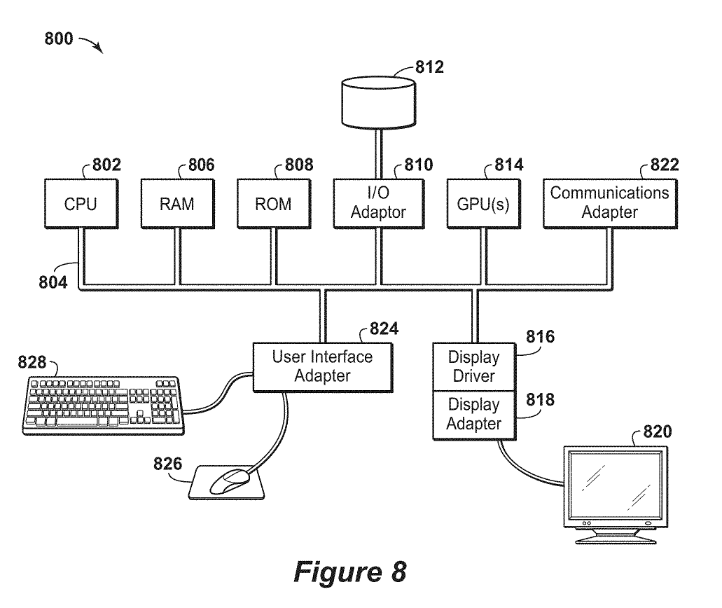

As an example, FIG. 8 is a block diagram of a computer system 800 that may be used to perform any of the methods disclosed herein. A central processing unit (CPU) 802 is coupled to system bus 804. The CPU 802 may be any general-purpose CPU, although other types of architectures of CPU 802 (or other components of exemplary system 800) may be used as long as CPU 802 (and other components of system 800) supports the inventive operations as described herein. The CPU 802 may execute the various logical instructions according to disclosed aspects and methodologies. For example, the CPU 802 may execute machine-level instructions for performing processing according to aspects and methodologies disclosed herein.

The computer system 800 may also include computer components such as a random access memory (RAM) 806, which may be SRAM, DRAM, SDRAM, or the like. The computer system 800 may also include read-only memory (ROM) 808, which may be PROM, EPROM, EEPROM, or the like. RAM 806 and ROM 808 hold user and system data and programs, as is known in the art. The computer system 800 may also include an input/output (I/O) adapter 810, one or more graphical processor units (GPU(s)) 814, a communications adapter 822, a user interface adapter 824, and a display adapter 818. The I/O adapter 810, the user interface adapter 824, and/or communications adapter 822 may, in certain aspects and techniques, enable a user to interact with computer system 800 to input information.

The I/O adapter 810 preferably connects a storage device(s) 812, such as one or more of hard drive, compact disc (CD) drive, floppy disk drive, tape drive, etc. to computer system 800. The storage device(s) may be used when RAM 806 is insufficient for the memory requirements associated with storing data for operations of embodiments of the present techniques. The data storage of the computer system 800 may be used for storing information and/or other data used or generated as disclosed herein. The communications adapter 822 may couple the computer system 800 to a network (not shown), which may enable information to be input to and/or output from system 800 via the network (for example, a wide-area network, a local-area network, a wireless network, any combination of the foregoing). User interface adapter 824 couples user input devices, such as a keyboard 828, a pointing device 826, and the like, to computer system 800. The display adapter 818 is driven by the CPU 802 to control, through a display driver 816, the display on a display device 820. Information and/or representations of one or more 2D canvases and one or more 3D windows may be displayed, according to disclosed aspects and methodologies.

The architecture of system 800 may be varied as desired. For example, any suitable processor-based device may be used, including without limitation personal computers, laptop computers, computer workstations, and multi-processor servers. Moreover, embodiments may be implemented on application specific integrated circuits (ASICs) or very large scale integrated (VLSI) circuits. In fact, persons of ordinary skill in the art may use any number of suitable structures capable of executing logical operations according to the embodiments.

As may be appreciated, the method may be implemented in machine-readable logic, such that a set of instructions or code that, when executed, performs the instructions or operations from memory. By way of example, the computer system includes a processor; an input device and memory. The input device is in communication with the processor and is configured to receive input data associated with a subsurface region. The memory is in communication with the processor and the memory has a set of instructions, wherein the set of instructions, when executed, are configured to: obtain a framework associated with a subsurface region, wherein the framework comprises a plurality of objects, wherein the plurality of objects comprise one or more of faults, horizons, and any combination thereof; generate a background mesh for the framework, wherein the background mesh comprises a plurality of cells; compute one or more level set functions for at least one of the plurality of objects; split one or more of the plurality of cells to conform to the plurality of objects within the framework to create a watertight model; and output the watertight model.

Further, the set of instructions may also be configured to: compute a distance value from a specified object to a node in the background mesh; compute a distance value based on a Manhattan distance; compute a distance value based on a Euclidian distance; individually perform for each object, the compute one or more level set functions instructions and the split one or more of the cells instructions; assign properties to one or more of the plurality of cells in the watertight model to form a subsurface model; simulate fluid flow within the subsurface model having the assigned properties to create simulation results; output simulation results to a display; output watertight model on a display; define an order for the plurality of objects, wherein the defined order for the plurality of objects represents a structural and/or stratigraphic interpretation of the inputted objects; and/or wherein the set of instructions that are further configured to split one or more of the plurality of cells to conform to the plurality of objects within the framework to create a watertight model are further configured to: identify one or more first cells that intersect with a first object of the plurality of objects, and identify one or more second cells that intersect with a second object of the plurality of objects, but excluding each cell that is one of the one or more first cells, wherein the first object has a higher priority in the defined order for the plurality of objects as compared to the second object, and truncate a portion of the second object that is associated with the one or more first cells. Further, the set of instructions may be configured to extend to meet another object or a boundary the one or more level set functions; compute the level set function value at the new nodes of the background mesh during expansion by solving a partial differential equation; use an expected surface expansion direction or a normal direction of the expanded object in the partial differential equation calculation; and/or determine the normal direction of the expansion as the normal of the object at the front edge or the object that fits the object's front and the user specified points ahead of the front.

It should be understood that the preceding is merely a detailed description of specific embodiments of the invention and that numerous changes, modifications, and alternatives to the disclosed embodiments can be made in accordance with the disclosure here without departing from the scope of the invention. The preceding description, therefore, is not meant to limit the scope of the invention. Rather, the scope of the invention is to be determined only by the appended claims and their equivalents. It is also contemplated that structures and features embodied in the present examples can be altered, rearranged, substituted, deleted, duplicated, combined, or added to each other. As such, it will be apparent, however, to one skilled in the art, that many modifications and variations to the embodiments described herein are possible. All such modifications and variations are intended to be within the scope of the present invention, as defined by the appended claims.

1. A method for generating a subsurface model having one or more object for a subsurface region comprising:
obtaining a framework associated with a subsurface region, wherein the framework comprises a plurality of objects, wherein the plurality of objects comprise one or more of faults, horizons, and any combination thereof;
generating a background mesh for the framework, wherein the background mesh comprises a plurality of cells;
computing one or more level set functions for at least one of the plurality of objects;
splitting one or more of the plurality of cells to conform to the plurality of objects within the framework to create a watertight model; and
outputting the watertight model.

2. The method of claim 1, wherein the level set function is an implicit function that defines one or more objects.

3. The method of claim 1, wherein the level set function is a distance function, wherein the distance function is configured to compute a distance value from a specified object to a node in the background mesh.

4. The method of claim 3, wherein the distance function is based on a Manhattan distance that is computed by propagating the distance from a first point to a second point.

5. The method of claim 3, wherein the distance function is based on a Euclidian distance that is computed between a first point to a second point.

6. The method of claim 1, wherein the computing one or more level set functions for at least one of the plurality of objects and the splitting one or more of the plurality of cells to conform to the plurality of objects within the framework to create a watertight model is performed for each of the plurality of objects individually.

7. The method of claim 1, further comprising assigning properties to one or more of the plurality of cells in the watertight model to form a subsurface model.

8. The method of claim 7, wherein the subsurface model is a geologic model and the properties comprise one or more of facies, lithology, porosity, permeability, or the proportion of sand and shale, and any combination thereof.

9. The method of claim 7, wherein the subsurface model is a reservoir model and the properties comprise one or more of porosity, permeability and any combination thereof.

10. The method of claim 9, further comprising simulating fluid flow within the reservoir model to create simulation results.

11. The method of claim 10, further comprising managing hydrocarbon operations based on the simulation results.

12. The method of claim 1, comprising defining an order for the plurality of objects.

13. The method of claim 12, wherein the defined order for the plurality of objects represents a structural and/or stratigraphic interpretation of the inputted objects.

14. The method of claim 12, wherein splitting one or more of the plurality of cells to conform to the plurality of objects within the framework to create a watertight model further comprises:
identifying one or more first cells that intersect with a first object of the plurality of objects; and
identifying one or more second cells that intersect with a second object of the plurality of objects, but excluding each cell that is one of the one or more first cells; wherein the first object has a higher priority in the defined order for the plurality of objects as compared to the second object; and
truncating a portion of the second object that is associated with the one or more first cells.

15. The method of claim 1, wherein the splitting one or more of the plurality of cells to conform to the plurality of objects within the framework to create a watertight model; further comprising:
performing a review of the plurality of cells that are split;
identifying whether one or more of the cells are below an element quality metric threshold; and
modifying the identified cells to revise the mesh used to create the watertight model.

16. The method of claim 1, wherein one or more level set functions are extended to meet another object or a boundary.

17. The method of claim 1, wherein the level set function value at the new nodes of the background mesh during expansion are obtained by solving a partial differential equation.

18. The method of claim 17, wherein an expected surface expansion direction or a normal direction of the expanded object is included in the partial differential equation.

19. The method of claim 18, wherein the normal direction of the expansion is selected as the normal of the object at the front edge or the object that fits the object's front and the user specified points ahead of the front.

20. A system for generating a subsurface model having one or more objects associated with a subsurface region, comprising:
a processor;
an input device in communication with the processor and configured to receive input data associated with a subsurface region;
memory in communication with the processor, the memory having a set of instructions, wherein the set of instructions, when executed, are configured to:
obtain a framework associated with a subsurface region, wherein the framework comprises a plurality of objects, wherein the plurality of objects comprise one or more of faults, horizons, and any combination thereof;
generate a background mesh for the framework, wherein the background mesh comprises a plurality of cells;
compute one or more level set functions for at least one of the plurality of objects;
split one or more of the plurality of cells to conform to the plurality of objects within the framework to create a watertight model; and
output the watertight model.

21. The system of claim 20, wherein the set of instructions configured to compute one or more level set functions for at least one of the plurality of objects are further configured to compute a distance value from a specified object to a node in the background mesh.

22. The system of claim 20, wherein the set of instructions configured to compute one or more level set functions for at least one of the plurality of objects are further configured to compute a distance value based on a Manhattan distance.

23. The system of claim 20, wherein the set of instructions configured to compute one or more level set functions for at least one of the plurality of objects are further configured to compute a distance value based on a Euclidian distance.

24. The system of claim 20, wherein the set of instructions are configured to compute one or more level set functions for at least one of the plurality of objects and to split one or more of the plurality of cells to conform to the plurality of objects within the framework to create a watertight model for each of the plurality of objects individually.

25. The system of claim 20, wherein the set of instructions, when executed, are further configured to: assign properties to one or more of the plurality of cells in the watertight model to form a subsurface model.

26. The system of claim 25, wherein the set of instructions, when executed, are further configured to: simulate fluid flow within the subsurface model having the assigned properties to create simulation results.

27. The system of claim 26, wherein the set of instructions, when executed, are further configured to: output simulation results to a display.

28. The system of claim 26, wherein the set of instructions, when executed, are further configured to: output watertight model on a display.

29. The system of claim 20, wherein the set of instructions, when executed, are further configured to: define an order for the plurality of objects, wherein the defined order for the plurality of objects represents a structural and/or stratigraphic interpretation of the inputted objects.

30. The system of claim 20, wherein the set of instructions that are further configured to split one or more of the plurality of cells to conform to the plurality of objects within the framework to create a watertight model are further configured to:
identify one or more first cells that intersect with a first object of the plurality of objects; and
identify one or more second cells that intersect with a second object of the plurality of objects, but excluding each cell that is one of the one or more first cells; wherein the first object has a higher priority in the defined order for the plurality of objects as compared to the second object; and
truncate a portion of the second object that is associated with the one or more first cells.
